(19) United States
(12) Patent Application Publication
(10) Pub. No.: US 2014/0166133 A1
(43) Pub. Date: Jun. 19, 2014

(54) MICROFLUIDIC DEVICE AND MICROFLUIDIC CHIP THEREOF

(71) Applicant: National Pingtung University of Science & Technology, (US)

(72) Inventors: Lung-Ming FU, Pingtung County (TW); Yao-Nan WANG, Pingtung County (TW)

(73) Assignee: National Pingtung University of Science & Technology, Pingtung County (TW)

(21) Appl. No.: 13/754,123

(22) Filed: Jan. 30, 2013

(30) Foreign Application Priority Data
Dec. 17, 2012 (TW) 101147831

(51) Int. Cl. G01N 1/28

(52) U.S. Cl. CPC G01N 1/28
USPC 137/565.01

(57) ABSTRACT

A microfluidic device including a microfluidic channel formed in a face of a substrate. The microfluidic channel is discontinuous and includes a first channel and a second channel not connected to the first channel. A pressure change section is formed between the first and second channels. The first channel is in communication with a first fluid port. The second channel is in communication with a second fluid port. An elastic membrane is applied to the face of the substrate. The elastic membrane includes a deformation area aligned with the pressure change section. A remaining portion of the elastic membrane outside of the deformation area forms a clinging area. The clinging area clings to a remaining area of the face of the substrate outside of the pressure change section. A fluid conveying member is in communication with one of the first and second fluid ports.

### BACKGROUND OF THE INVENTION

1. Field of the Invention

The present invention relates to a microfluidic device and a microfluidic chip thereof and, more particularly, to a microfluidic device and a microfluidic chip thereof providing a function of a single direction valve.

2. Description of the Related Art

Microfluidic techniques are an important factor in fabrication of biochips for precisely controlling the standard flow speed and the standard flow of a fluid in a microfluidic channel for the purposes of enhancing the precision of the biochips in detection of the fluid.

Conventionally, the flow of the fluid in a biochip is controlled by opening and closing a valve. However, this requires a complicated micro pump involving difficulties in fabrication. Furthermore, the valve is liable to fatigue and damage under long-term high-pressure operation, failing to provide reliability and efficiency. In an essay entitled “Design, Fabrication, and Control of a Novel Micro-Peristaltic Pump” published in January 2006 by Cho et al. of Department of Mechanical and Mechatronic Engineering of National Taiwan Ocean University, a micro-peristaltic pump is disclosed and uses a slant membrane made of polydimethylsioxane (PDMS) as a valve. When an external force is applied to the slant membrane, it is able to cause continuous and asymmetric deformation of the slant membrane to push a fluid in a microfluidic channel forwards. However, a check valve is required to prevent backflow of the fluid when the slant membrane restores its shape.

Some manufacturers cover two opposite sides of a continuous microfluidic channel with elastic PDMS membranes. When the fluid flows through the microfluidic channel, an external force is applied to expand the elastic PDMS membranes, interrupting flow of the fluid in the microfluidic channel. However, an additional power source is required to control the operation of the PDMS membranes, causing consumption of energy and an increase in the costs. Furthermore, the processing procedures for mounting the PDMS membranes to two sides of the microfluidic channel are complicated and difficult. Thus, the above conventional microfluidic devices can not be widely used in various areas.

Thus, a need exists for a novel microfluidic device providing a function of a single direction valve to mitigate and/or obviate the above disadvantages.

### SUMMARY OF THE INVENTION

An objective of the present invention is to provide a microfluidic device and a microfluidic chip thereof for controlling flow of a fluid and preventing backflow of the fluid, maintaining the standard flow speed and standard flow of the fluid.

Another objective of the present invention is to provide a microfluidic device of a simple type and a microfluidic chip thereof.

The present invention fulfills the above objectives by providing, in a first aspect, a microfluidic device including a substrate. A microfluidic channel is formed in a face of the substrate and is discontinuous. The microfluidic channel includes a first channel and a second channel not connected to the first channel. A pressure change section is formed between the first and second channels. The first channel is in communication with a first fluid port. The second channel is in communication with a second fluid port. An elastic membrane is applied to the face of the substrate. The elastic membrane includes a deformation area aligned with and not clung to the pressure change section. A remaining portion of the elastic membrane outside of the deformation area forms a clinging area. The clinging area clings to a remaining area of the face of the substrate outside of the pressure change section. A fluid conveying member is in communication with one of the first and second fluid ports.

In a second aspect, a microfluidic chip includes a substrate. A microfluidic channel is formed in a face of the substrate and is discontinuous. The microfluidic channel includes a first channel and a second channel not connected to the first channel. A pressure change section is formed between the first and second channels. The first channel is in communication with a first fluid port. The second channel is in communication with a second fluid port. An elastic membrane is applied to the face of the substrate. The elastic membrane includes a deformation area aligned with the pressure change section. The deformation area is deformable and expandable away from the face of the substrate relative to the pressure change section. A remaining portion of the elastic membrane outside of the deformation area forms a clinging area. The clinging area clings to a remaining area of the face of the substrate outside of the pressure change section.

The fluid conveying member can be a reciprocal pump connected to one of the first and second fluid ports by a pipe.

In an example, the substrate further includes first and second end edges, and the face extends between the first and second end edges. The microfluidic channel is located between the first and second end edges. A first fluid passage extends between the first channel and the first fluid port. A second fluid passage extends between the second channel and the second fluid port.

In another example, the substrate further includes first and second end edges, and the microfluidic channel extends from the first end edge through the second end edge of the substrate. The first fluid port is an end opening of the microfluidic channel in the first end edge. The second fluid port is the other end opening of the microfluidic channel in the second end edge.

In an example, each of the first and second channels has a fluid flow end. The fluid flow ends of the first and second channels are aligned with each other. The pressure change section is formed between the fluid flow ends of the first and second channels.

The elastic membrane can be a polydimethylsioxane (PDMS) membrane.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a microfluidic device according to the present invention.

FIG. 2 shows a top view of the microfluidic device after assembly.

FIG. 3 shows a cross sectional view taken along section line 3-3 of FIG. 2.

FIG. 4 shows a cross sectional view of an alternative embodiment of the microfluidic chip.

FIG. 5 is a view similar to FIG. 3, illustrating operation of the microfluidic device, with a fluid conveying member pushing a fluid into a first channel of a microfluidic channel.

FIG. 6 is a view similar to FIG. 5, with a deformation area of an elastic membrane deforming to allow the fluid to flow from the first channel to a second channel of the microfluidic channel.

FIG. 7 is a view similar to FIG. 6, with the deformation area of the elastic membrane restoring its shape to interrupt the flow of the fluid.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

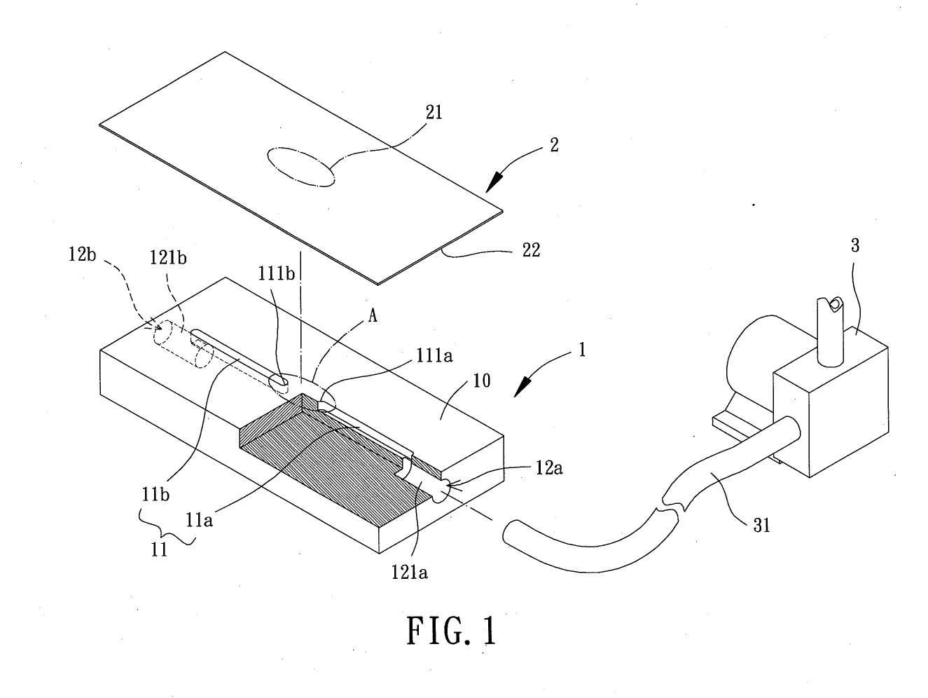

With reference to FIGS. 1 through 3, a microfluidic device according to the present invention includes a substrate 1, an elastic membrane 2 and a fluid conveying member 3. The elastic membrane 2 covers the substrate 1. The fluid conveying member 3 supplies a fluid flowing between the substrate 1 and the'elastic membrane 2.

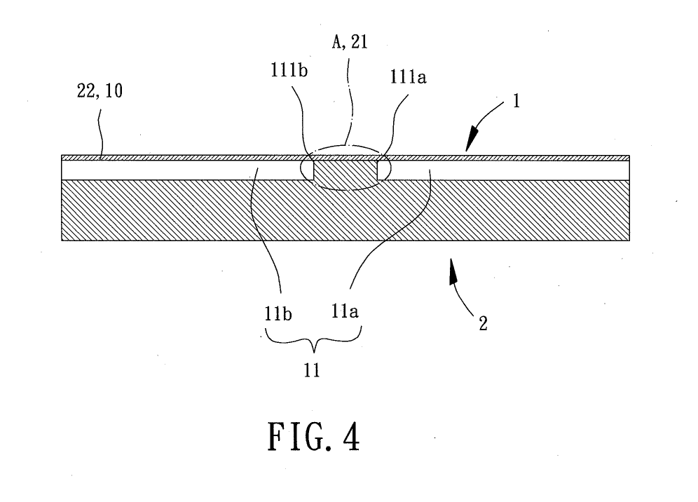

The substrate 1 can be obtained by processing an easy-to-process workpiece made of acrylic acid, glass, or chemical resistant plastic. A microfluidic channel 11 is formed in a face 10 of the substrate 1. The face 10 extends between first and second end edges of the substrate 1. The microfluidic channel 11 is discontinuous (namely, consisting of two or more independent channels not connecting to each other). In the form shown, the microfluidic channel 11 is located between the first and second end edges. The microfluidic channel 11 can be formed by stamping, laser processing, etc. Alternatively, the microfluidic channel 11 can extend from the first end edge through the second end edge of the substrate 1 as shown in FIG. 4.

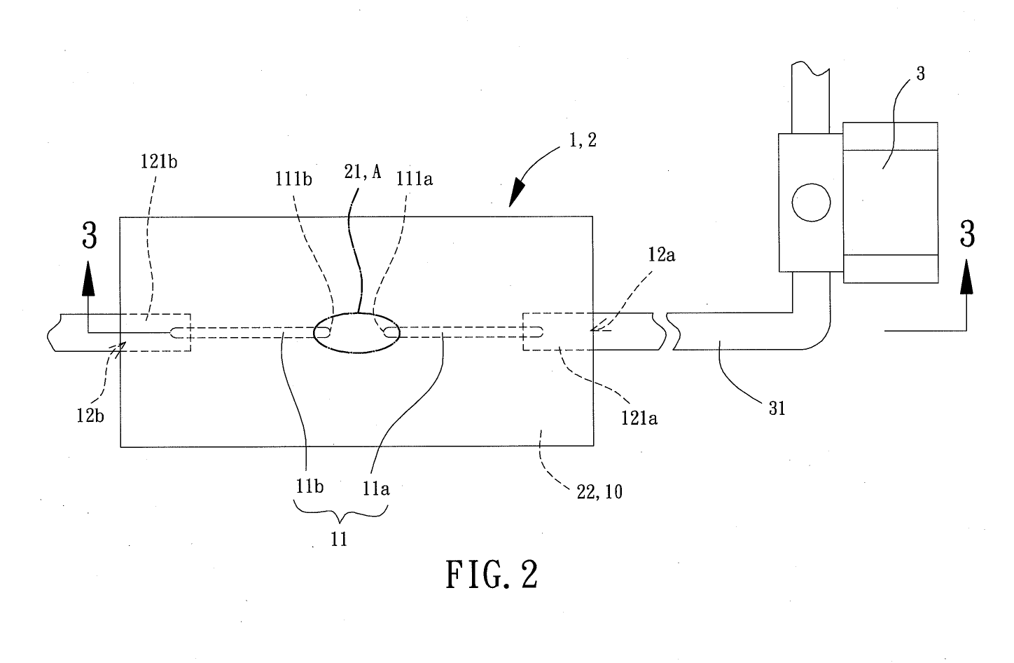

The microfluidic channel 11 includes a first channel 11a and a second channel 11b not connected to the first channel 11a. A pressure change section “A” is formed between the first and second channels 11a and 11b. Namely, the first and second channels 11a and 11b are connected to each other by the pressure change section “A” to allow flow of a fluid. With reference to FIG. 2, each of the first and second channels 11a and 11b includes a fluid flow end 111a, 111b. The fluid flow ends 111a and 111b of the first and second channels 11a and 11b are aligned with each other. The pressure change section “A” is formed between and partially overlaps the fluid flow ends 111a and 111b. The area of the pressure change section “A” can be varied according to actual need, allowing the fluid to flow from one of the first and second channels 11a and 11b to the other of the first and second channels 11a and 11b. The first channel 11a is in communication with a first fluid port 12a. The second channel 11b is in communication with a second fluid port 12b. In the form shown, the first fluid port 12a is formed in the first end edge of the substrate 1, and the second fluid port 12b is formed in the second end edge of the substrate 1. Furthermore, a first fluid passage 121 a extends between the first channel 11a and the first fluid port 12a. A second fluid passage 121b extends between the second channel 11b and the second fluid port 12b. Alternatively, the first fluid port 12a is an end opening of the microfluidic channel 11 in the first end edge of the substrate 1, and the second fluid port 12b is the other end opening of the microfluidic channel 11 in the second end edge of the substrate 1.

With reference to FIGS. 1 and 2, the elastic membrane 2 can be an elastic deformable soft membrane, particularly a polydimethylsioxane (PDMS) membrane. Thus, the elastic membrane 2 can be in tight contact with the substrate 1 due to the surface clinging properties of the elastic membrane 2. In the form shown, a surface of the elastic membrane 2 is applied to the face 10 of the substrate 1. The elastic membrane 2 includes a deformation area 21 aligned with the pressure change section “A.” The deformation area 21 is deformable and expandable away from the face 10 of the substrate 11 relative to the pressure change section “A.” A remaining portion of the elastic membrane 2 outside of the deformation area 21 forms a clinging area 22. The clinging area 22 clings to a remaining area of the face 10 of the substrate 1 outside of the pressure change section “A.” Other provisions for engaging the elastic membrane 2 with the substrate 1 without bonding the deformation area 21 with the substrate 1 can be used, as it can be readily appreciated by one having ordinary skill in the art.

With reference to FIG. 1, the fluid conveying member 3 is in communication with one of the first and second fluid ports 12a and 12b. The fluid conveying member 3 causes the fluid to flow in the microfluidic channel 11 and changes the pressure at the pressure change section “A,” causing deformation of the deformation area 21 of the elastic membrane 2. In the form shown, the fluid conveying member 3 is a reciprocal pump connected to the first fluid port 12a by a pipe 31. However, the fluid conveying member 3 can be any device capable of causing flow of fluids.

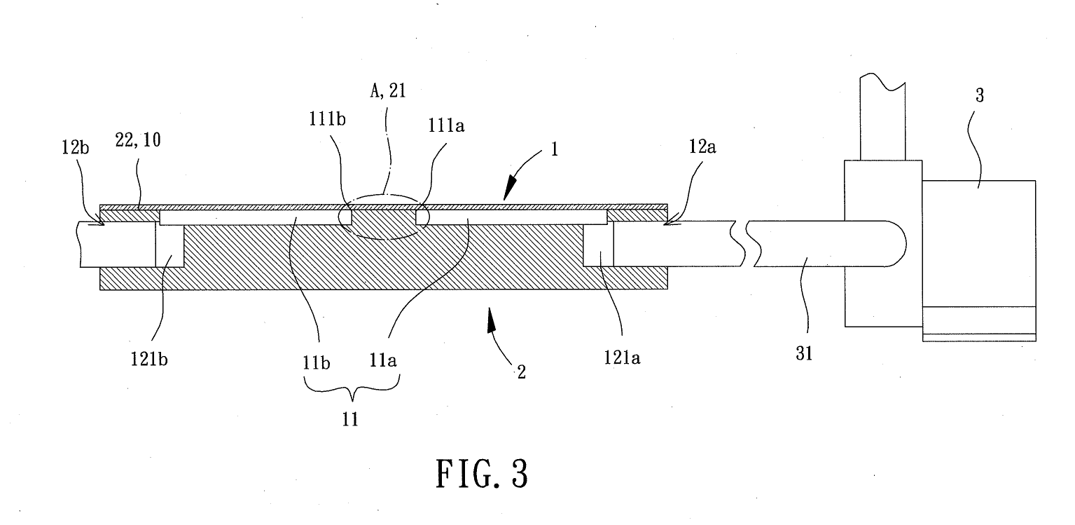

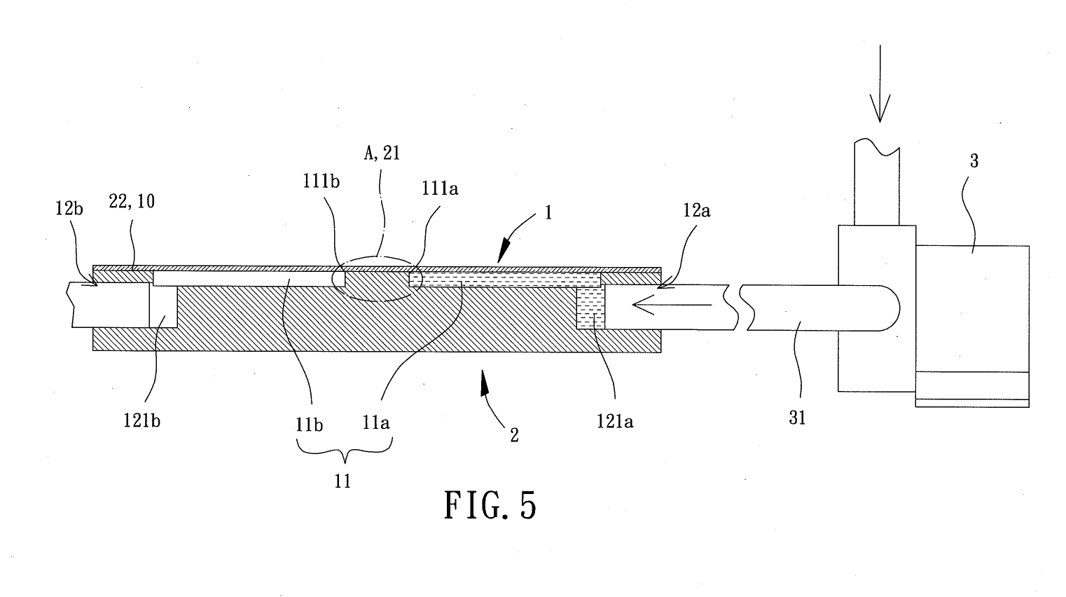

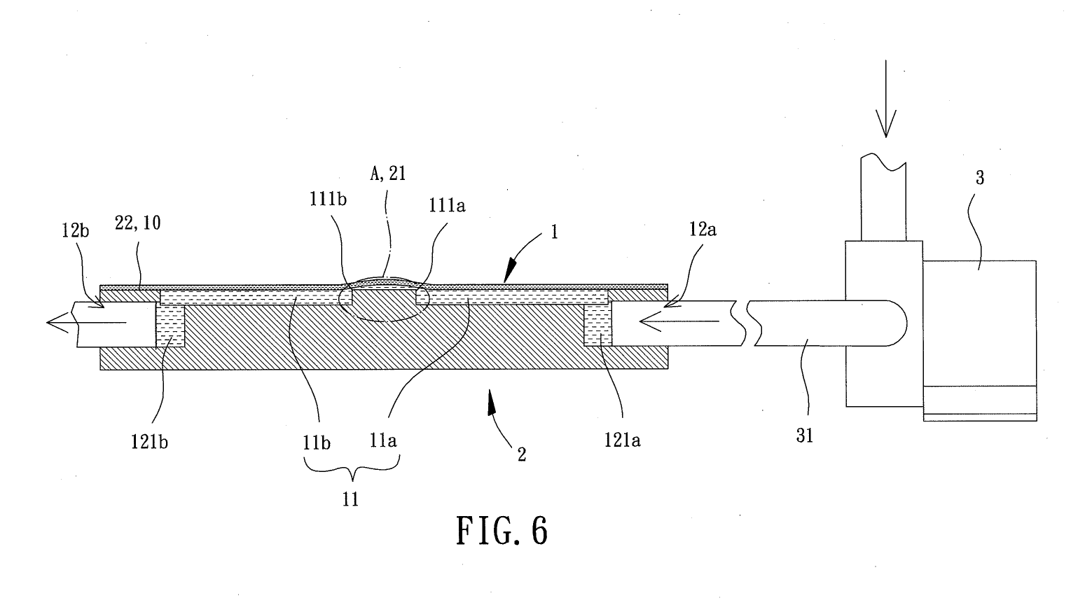

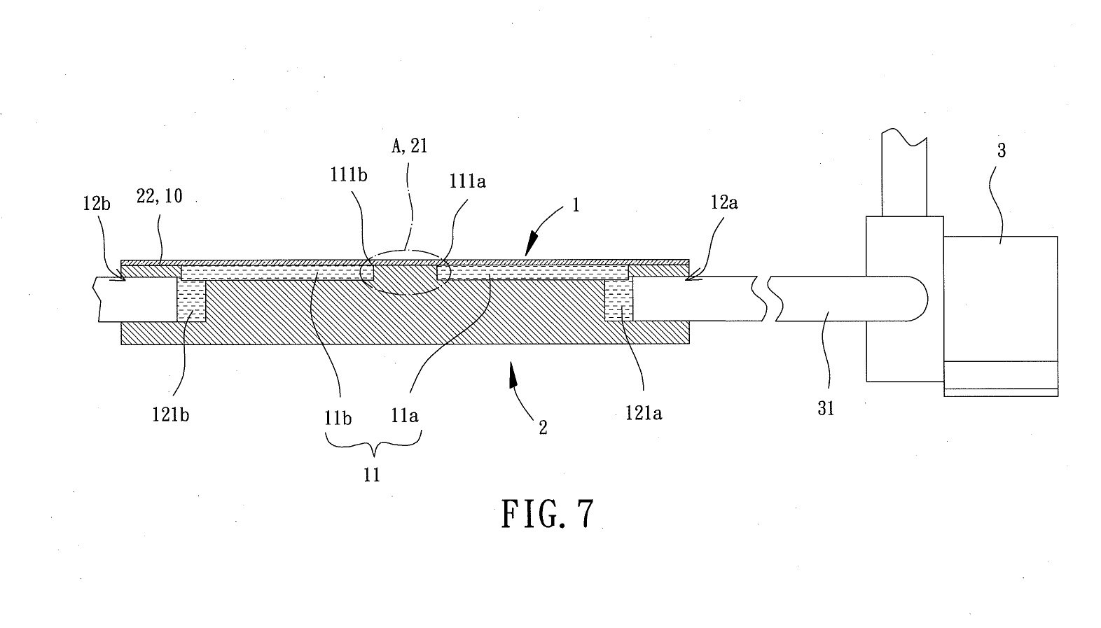

FIG. 3 shows the microfluidic device after the elastic membrane 2 is applied to the substrate 1, and only the deformation area 21 is deformable relative to the pressure change section “A.” Operation of the microfluidic device will now be set forth with reference to FIGS. 5-7.

With reference to FIG. 5, when the fluid conveying member 3 pushes the fluid to flow into the first channel 11 a and continuously applies pressure to the pressure change section “A,” the deformation area 21 of the elastic membrane 2 deforms under the fluid pressure. The deformation area 21 expands relative to the pressure change section “A,” forming a fluid passage between the deformation area 21 and the pressure change section “A.” Thus, the fluid can flow from the first channel 11a to the second channel 11b through the pressure change section “A.” On the other hand, if the fluid conveying member 3 stops conveying fluid or is gaining fluid from the outside, the pressure change section “A” is no longer under pressure. Thus, the deformation area 21 of the elastic membrane 21 restores its flat shape and clings to the pressure change section “A” again, avoiding backflow of the fluid from the second channel 11b to the first channel 11a. Thus, the elastic membrane 2 acts as a single direction valve to prevent backflow of the fluid, which more efficiently controls the flow of the fluid in the microfluidic channel 11.

In view of the foregoing, the main features of the microfluidic device in the embodiment are that by applying the elastic membrane 2 to the substrate 1 with the deformation area 21 deformable relative to the pressure change section “A,” the deformation area 21 of the elastic membrane 21 can change its shape in response to a pressure change, providing fluid communication between the first and second channels 11a and 11b of the microfluidic channel 11 when the deformation area 21 deforms. On the other hand, the fluid communication is interrupted when the deformation area 21 does not deform. Thus, the elastic membrane 2 serves as a single direction valve to provide a microfluidic device and its microfluidic chip with a simple structure. Backflow of the fluid can be effectively prevented while controlling the flow of the fluid, maintaining the standard fluid speed and the standard flow.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A microfluidic device comprising:
a substrate including a face, with a microfluidic channel formed in the face of the substrate, with the microfluidic channel being discontinuous and including a first channel and a second channel not connected to the first channel, with a pressure change section formed between the first and second channels, with the first channel in communication with a first fluid port, with the second channel in communication with a second fluid port;
an elastic membrane applied to the face of the substrate, with the elastic membrane including a deformation area aligned with the pressure change section, with a remaining portion of the elastic membrane outside of the deformation area forming a clinging area, with the clinging area clung to a remaining area of the face of the substrate outside of the pressure change section; and
a fluid conveying member in communication with one of the first and second fluid ports.

2. The microfluidic device as claimed in claim 1, with the substrate further including first and second end edges, with the face extending between the first and second end edges, with the microfluidic channel located between the first and second end edges, with a first fluid passage extending between the first channel and the first fluid port, and with a second fluid passage extending between the second channel and the second fluid port.

3. The microfluidic device as claimed in claim 1, with the substrate further including first and second end edges, with the microfluidic channel extending from the first end edge through the second end edge of the substrate, with the first fluid port being an end opening of the microfluidic channel in the first end edge, and with the second fluid port being another end opening of the microfluidic channel in the second end edge.

4. The microfluidic device as claimed in claim 1, with each of the first and second channels having a fluid flow end, with the fluid flow ends of the first and second channels aligned with each other, and with the pressure change section formed between the fluid flow ends of the first and second channels.

5. The microfluidic device as claimed in claim 1, with the elastic membrane being a polydimethylsioxane (PDMS) membrane.

6. The microfluidic device as claimed in claim 1, with the fluid conveying member being a reciprocal pump, and with the reciprocal pump connected to one of the first and second fluid ports by a pipe.

7. A microfluidic chip comprising:
a substrate including a face, with a microfluidic channel formed in the face of the substrate, with the microfluidic channel being discontinuous and including a first channel and a second channel not connected to the first channel, with a pressure change section formed between the first and second channels, with the first channel in communication with a first fluid port, with the second channel in communication with a second fluid port; and
an elastic membrane applied to the face of the substrate, with the elastic membrane including a deformation area aligned with the pressure change section, with the deformation area deformable and expandable away from the face of the substrate relative to the pressure change section, with a remaining portion of the elastic membrane outside of the deformation area forming a clinging area, with the clinging area clung to a remaining area of the face of the substrate outside of the pressure change section.

8. The microfluidic chip as claimed in claim 7, with the substrate further including first and second end edges, with the face extending between the first and second end edges, with the microfluidic channel located between the first and second end edges, with a first fluid passage extending between the first channel and the first fluid port, and with a second fluid passage extending between the second channel and the second fluid port.

9. The microfluidic chip as claimed in claim 7, with the substrate further including first and second end edges, with the microfluidic channel extending from the first end edge through the second end edge of the substrate, with the first fluid port being an end opening of the microfluidic channel in the first end edge, and with the second fluid port being another end opening of the microfluidic channel in the second end edge.

10. The microfluidic chip as claimed in claim 7, with each of the first and second channels having a fluid flow end, with the fluid flow ends of the first and second channels aligned with each other, and with the pressure change section formed between the fluid flow ends of the first and second channels.

11. The microfluidic chip as claimed in claim 7, with the elastic membrane being a polydimethylsioxane (PDMS) membrane.
